(19) United States
(12) Patent Application Publication
(10) Pub. No.: US 2009/0123897 A1
(43) Pub. Date: May 14, 2009

(54) System, method and article of manufacture for entertaining, educating and soothing patient awake during dental or medical procedure

(76) Inventors: Janet Shangle, Burr Ridge, IL (US); Jennifer Haras, Lemont, IL (US); Gwen Shangle, Orange Park, FL (US)

Correspondence Address: JAMES RAY & ASSOCIATES, 2840 PITCAIRN ROAD, MONROEVILLE, PA, 15146, US

(21) Appl. No.: 12/291,714

(22) Filed: Nov. 13, 2008

Related U.S. Application Data
(60) Provisional application No. 61/002,939, filed on Nov. 13, 2007.

(51) Int. Cl. A63F 9/06; G09B 23/28

(52) U.S. Cl. 434/263; 273/153 R

(57) ABSTRACT

A picture puzzle includes a background having at least one background object and at least one puzzle object disposed on such background. The picture puzzle is adapted with a predetermined matching alignment between a predetermined feature of the at least one puzzle object and a predetermined feature of the at least one background object. A method of using at least one picture puzzle for at least one of entertaining and soothing a patient awake during medical or dental procedure and promoting personal hygiene and a system for entertaining and soothing a patient awake during medical or dental procedure are also provided.

### CROSS-REFERENCE TO RELATED APPLICATIONS

This application is related to and claims priority from Provisional Patent Application Ser. No. 61/002,939 filed on Nov. 13, 2007.

### FIELD OF THE INVENTION

The present invention relates, in general, to picture puzzles and, more particularly, this invention relates to system, method and article of manufacture for entertaining, educating and soothing a patient awake during medical or dental procedure.

### BACKGROUND OF THE INVENTION

As is generally well known, patients often experience anxiety and discomfort when undergoing medical or dental procedure while being awake. Particularly during a dental procedure, the patient may be confined to a dental chair for prolong periods of time. The effort to maintain open mouth during such prolong periods of time further increases the anxiety and discomfort levels. Yet, the patients are presented with limited means for keeping their focus and attention off the dental procedure.

Prior to the design and conception of the present invention, some dental offices have posters strategically placed within a predetermined location to capture patient's attention in an attempt to alleviate such anxiety and discomfort. However, the availability and variety of presently available posters have been found to be less than satisfactory, thus causing the patients to continuously view the same posters during periodic procedures and causing the dental or medical professionals to periodically change locations of the posters.

Lately, use of TV sets and with optional VCR and DVD players connected to such TV sets mounted has gained limited acceptance within the dental office environment. However, to the best of Applicants' knowledge, there is not a single picture puzzle presently available on the market which can be adapted for entertaining and soothing a patient being awake during dental or medical procedure as well as educating the person in personal hygiene and care.

### SUMMARY OF THE INVENTION

In accordance with one aspect, the present invention provides a picture puzzle. The picture puzzle includes a background having at least one background object disposed therein. At least one puzzle object is disposed on the background. A predetermined matching alignment exists between a predetermined feature of the at least one puzzle object and a predetermined feature of the at least one background object.

In accordance with another aspect, the present invention provides a picture puzzle. The picture puzzle includes a background having at least one background object disposed therein. At least one puzzle object is disposed on the background. There is provided a substantial alignment of at least a portion of the predetermined feature of the at least one puzzle object with a substantially identical portion of the predetermined feature of the at least one background object. The picture puzzle also includes a substantial color match of the at least one puzzle object with the at least one background object. A substantial size match of the at least one puzzle object with the predetermined feature of the at least one background object, a substantial shape match of the at least one puzzle object with the predetermined feature of the at least one background object and a substantial angular match of the at least one puzzle object with the predetermined feature of the at least one background object are also employed in the present invention. A predetermined opacity of the at least one puzzle object is provided in a predetermined relationship to the at least one background object. A predetermined color density of the at least one puzzle object is also provided in a predetermined relationship to the at least one background object.

In accordance with yet another aspect, the present invention provides a method of using at least one picture puzzle for at least one of entertaining and soothing a patient awake during medical or dental procedure and promoting personal hygiene. The method includes the step of providing the at least one picture puzzle having a background and at least one background object disposed thereon. Then, positioning, on the background, at least one puzzle object closely related to the medical or dental procedure. Next, aligning a predetermined feature of the at least one puzzle object with a predetermined feature of the at least one background object. Positioning the at least one picture puzzle in a predetermined location relative to a position of the patient during the medical or dental procedure. Finally, finding, by the patient, the at least one puzzle object disposed within the background.

In accordance with a further aspect, the present invention provides a system for entertaining and soothing a patient awake during medical or dental procedure. The system includes at least one picture puzzle positioned in a predetermined location so as to be directly viewed by a patient undergoing such medical or dental procedure. The at least one picture puzzle includes a background having at least one background object disposed therein. At least one puzzle object is disposed on the background. The at least one picture puzzle is provided with a predetermined matching alignment between a predetermined feature of the at least one puzzle object and a predetermined feature of the at least one background object.

In accordance with another aspect, the present invention provides a method of using at least one picture puzzle for educating a person about at least one of tools used in a medical or dental procedure and items used in health care and personal hygiene. The method includes the step of providing at least one picture puzzle having a background and at least one background object disposed thereon. Positioning, on the background, at least one puzzle object closely related to the medical or dental procedure. Then, aligning a predetermined feature of the at least one puzzle object with a predetermined feature of the at least one background object. Next, finding, by the patient, the at least one puzzle object disposed within the background. Finally, learning, by the person, about use of the found at least one puzzle object.

### OBJECTS OF THE INVENTION

It is, therefore, one of the primary objects of the present invention to provide a system for entertaining and soothing a patient awake during medical or dental procedure.

Another object of the present invention is to provide a system for entertaining and soothing a patient awake during medical or dental procedure that employs at least one picture puzzle.

Yet another object of the present invention is to provide a picture puzzle for soothing a patient awake during medical or dental procedure that contains objects closely related to such practice.

A further object of the present invention is to provide a picture puzzle for soothing a patient awake during medical or dental procedure wherein the difference between the color of the background image and the color of the puzzle object image defines the difficulty level of the picture puzzle.

Yet a further object of the present invention is to provide a picture puzzle for soothing a patient awake during medical or dental procedure wherein the quantity of displayed puzzle object images defines the difficulty level of the picture puzzle.

Another object of the present invention is to provide a method of using at least one picture puzzle for entertaining and soothing a patient awake during medical or dental procedure.

Yet another object of the present invention is to provide a method of using at least one picture puzzle for educating a person in principles of hygiene and care.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a perspective view of a system for entertaining, educating and soothing a patient awake during medical or dental procedure;

FIG. 2 is one view of a picture puzzle for entertaining, educating and soothing a patient awake during medical or dental procedure;

FIG. 3 is another view of a picture puzzle for entertaining, educating and soothing a patient awake during medical or dental procedure;

FIG. 4 is yet another view of a picture puzzle for entertaining, educating and soothing a patient awake during medical or dental procedure; and

FIG. 5 is still another view of a picture puzzle for entertaining, educating and soothing a patient awake during medical or dental procedure.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

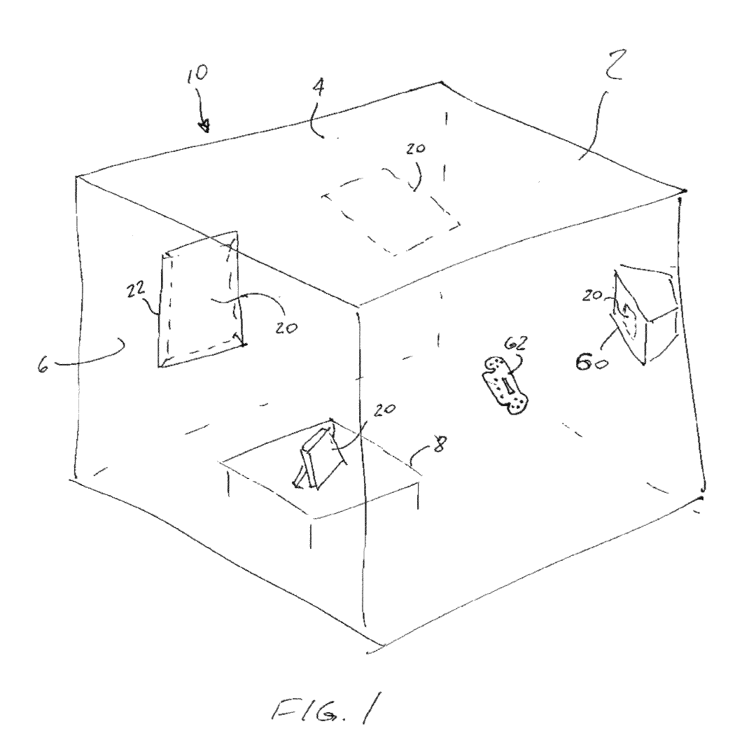

Now in reference to FIG. 1, therein is provided a system, generally designated as 10, for entertaining and soothing a patient awake during medical or dental procedure.

The present invention is illustrated and described in combination with a dental practice, although it will be apparent to those skilled in the relevant art that the present invention may be applied to other medical practices and as such should not be interpreted as a limiting factor of the system 10 of the present invention.

The system 10 includes at least one puzzle object 40 hidden within a background 30. The picture puzzle 20 is manufactured, in a digital format, by merging photograph of the puzzle object 40 within a photograph of the background 30 thus enhancing quality and appeal of the picture puzzle 20 over available “hide and seek” picture puzzles that use conventional drawings.

The present invention is further illustrated and described in combination with a picture puzzle 20 provided in a printed format and positioned in a predetermined location within a dental or medical office 2. For example, in a dental office 2, where the patient is generally laying in a dental chair (not shown), as to generally face the ceiling 4, the picture puzzle 20 will be preferably affixed to such ceiling 4. Or, the picture puzzle 20 may be affixed to a wall 6 or be placed, in a freestanding manner, onto a table 8 or even a floor upstanding stand (not shown).

The picture puzzle 20 includes a background 30 and at least one puzzle object 40 which is closely related to the dental practice and which is positioned in a predetermined alignment relative to a pre-selected feature or portion of the background image 30.

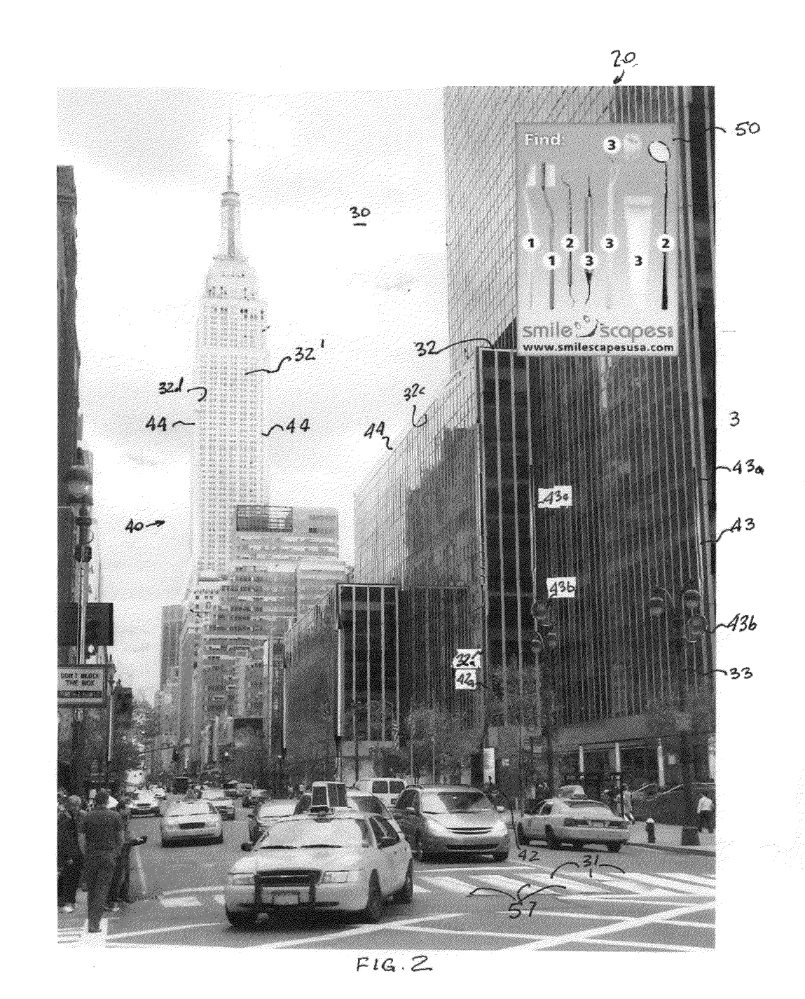

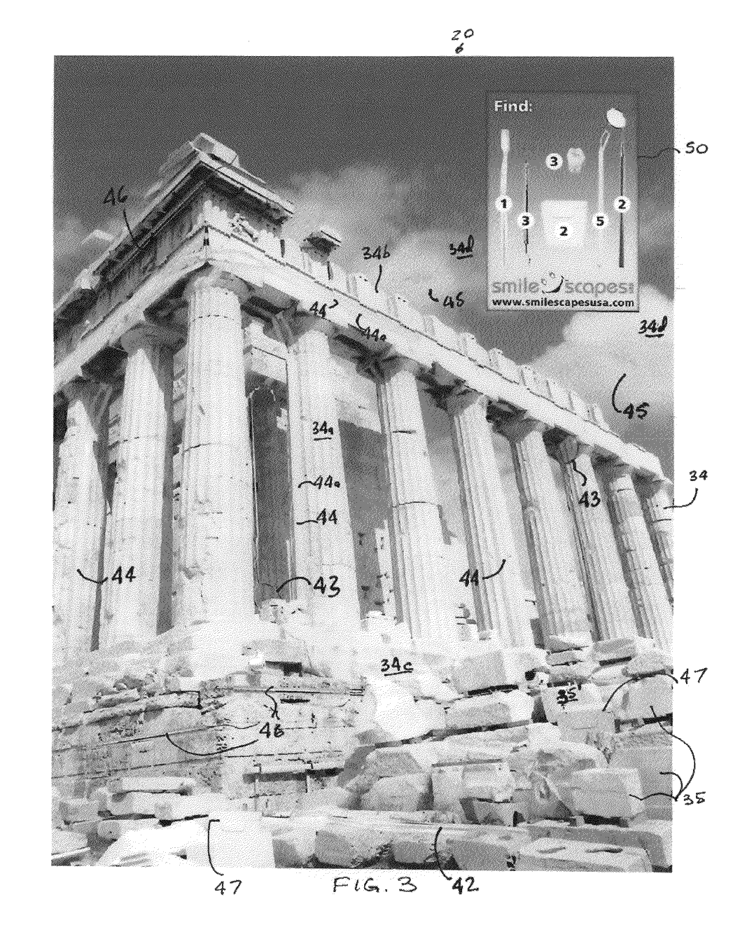

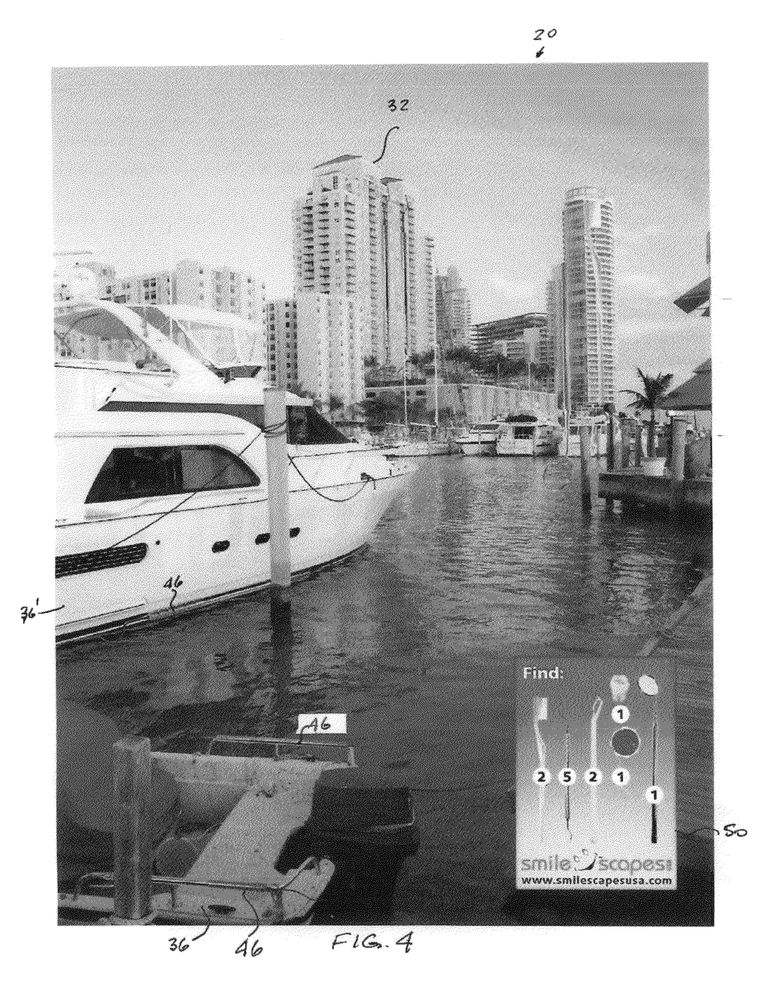

The background 30 can be selected from any one of the available themes. In accordance with one form of the invention, the background 30 depicts an architectural theme. By way of one example of FIG. 2, such architectural theme is an urban theme containing a plurality of buildings 32, lamp posts 33 and the like structures. By way of another example of FIG. 3, the background 30 depicts an architectural scheme, such as a structure 34 of a Greek temple, and a surrounding environment including stones 35. By way of another example of FIG. 4, the background 30 is selected as a recreational boating marina containing buildings 32 and watercrafts 36.

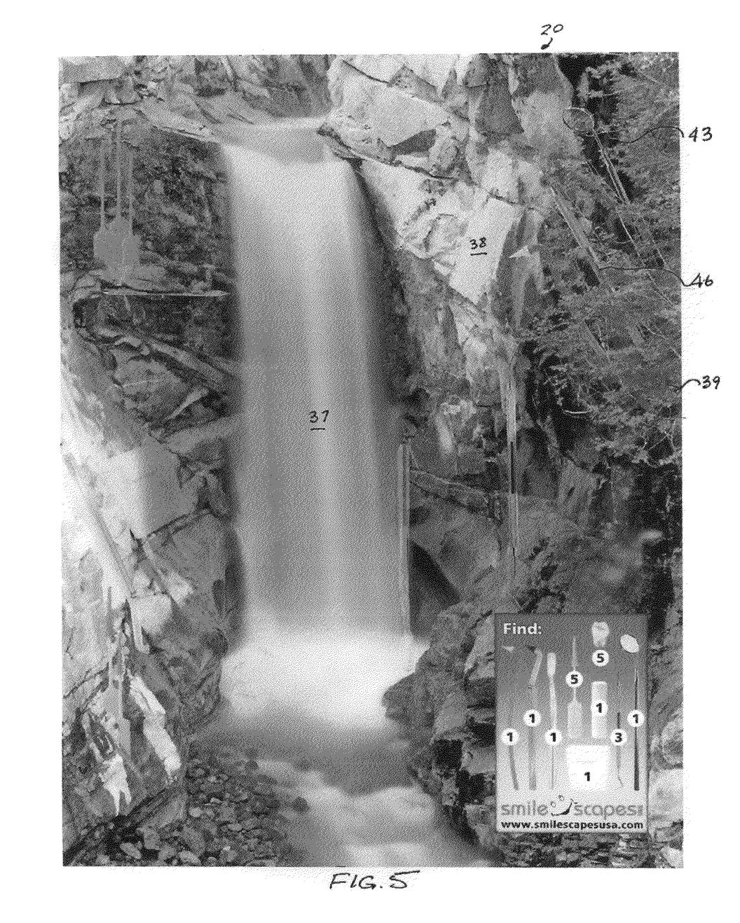

In accordance with another form of the invention, the background 30 of FIG. 5 is provided as a natural landscape containing waterfall 37, rocks 38 and trees 39.

Other background themes, such as wildlife, sports, entertainment and the like can be employed in the present invention.

As was stated above, the at least one puzzle object 40 is closely related to the dental practice. Such at least one puzzle object 40 may be selected from a group consisting of toothbrush, toothpaste, dental floss, probe, pigtail explorer, probe explorer, tooth and the like objects. It is presently preferred to provide a plurality of puzzle objects 40 and, more particularly, to sub divide such plurality of puzzle objects 40 into common shape groups. It will be appreciated that a difficulty level of the picture puzzle 20 will increase proportionally both to the number of puzzle objects 40 and number of common shape groups.

It is presently preferred to align at least a portion of each puzzle object 40 in a matching relationship with at least a portion of the contour of the image background 30. By way of one example of FIG. 2, the puzzle object 40, being a well known toothbrush 42, is positioned so as to generally align one side edge of the elongated handle 42a of the tooth brush 42 in a vertical direction with the vertical edge 32a of the building 32. Thus, such vertical edge 32a becomes the side edge of the handle 42a. In further reference to FIG. 2, one side edge of the elongated handle 43a of a dental mirror 43 is also aligned in the vertical direction with another vertical edge 32b of the building 32 and the mirror portion 43b is positioned in close proximity and in shape matching alignment with the lamp fixtures 33a of the lamp post 33. Yet in further reference to FIG. 2, a probe 44 is disposed in a horizontal direction so as to form an upper horizontal edge 32c of the building 32. In yet further reference to FIG. 2, one side edge of the elongated probe 44 is aligned in the vertical direction with a vertical edge 32d of the building 32′.

By way of another example of FIG. 3, the probe 44 is positioned so as to align one side edge of its elongated handle 44a in a vertical direction with a column 34a of the structure 34 and further aligned the side edge of the handle 44a with the side edge of such column 34a. Likewise, the handle 44a of the probe 44 may be aligned in a horizontal direction with the roof portion 34b of the structure 34.

By way of yet another example of FIG. 4, the probe explorer 46 forms a railing 36a of a watercraft 36 or is aligned with a hull portion 36b of the watercraft 36′ and further in close proximity to the water surface level providing a darker color similar to the color of such probe explorer 46.

By way of still another example of FIG. 5, each of the mirror 43 and the probe explorer 46 is aligned with a general direction of the branches of the trees 39.

Aligning a feature of the puzzle object 40 in a predetermined relationship to a feature of the portion of the background 30, has been found essential in increasing the difficulty level of picture puzzle 20. The highest difficulty of the picture puzzle is provided when a portion or a feature of the puzzle object 40 substantially merges with the like portion or a feature of the background 30.

It is also within the scope of the present invention to match the size of the at least one object 40 with size or sizes of the surrounding objects in the image background 30. By way of one example of FIG. 2, the length of each probe 44 is set generally equal to a length of the vertical edge of the building 32′. By way of another example of FIG. 4, the floss container 47 is sized generally equal to the size of the surrounding stones 35 and, more particularly, to the stone 35′ disposed in close proximity thereto.

It is also contemplated to dispose puzzle object 40 at an angle preselected to match the angle of the respective portion of the background 30 as best shown in FIG. 5 by inclining each of at least the mirror 43 and probe explorer 46.

It is also presently preferred to position puzzle object 40 so that its shape closely matches the shape of the surrounding background 30. By way of example of FIG. 4, the floss container 47 having a generally square shape is interposed between the background objects such as the stones 35 and is further positioned in close proximity to a stone 35′ having a like generally square shape. Aligning the shape of the puzzle object 40 in a predetermined relationship to the shape of the portion of the background 30, has been also found essential in increasing the difficulty level of picture puzzle 20.

The present invention contemplates selecting a color of each puzzle object 40 in a predetermined matching alignment with the portion of the background 30 having such puzzle object 40 placed thereon. Furthermore, it is contemplated to select a color contrast between the color of the object image 40 and the cooperating color of the background 30 at various pre-selected levels further defining the difficulty level of the picture puzzle 20. The colors of the puzzle object 40 and the background 30 that closely match each other, with the color contrast being substantially reduced, will represent the most difficult level of the picture puzzle 20. By way of the example of FIG. 3, the color of the probe 44 is preselected to closely match the color of the background roof portion 34b while the probe explorer 46 having a silver color is positioned within a foundation portion 34c characterized by a substantially matching grayish color. It would be appreciated that positioning the silver colored probe explorer 46 within the roof portion 34b will provide for a grater color contrast therebetween thus reducing difficulty of locating such probe explorer 46. Likewise, the teeth 45 generally characterized by an-off white color are placed within the background cloud objects 34d defined by a generally like color.

Oppositely, aligning the toothpaste container 57 with the crossing pattern 31 of FIG. 2 and further selecting the color of the toothpaste container 57 to closely match the color of the background object, such as a street crossing marking pattern 31, increases the difficulty level of the picture puzzle 20.

In addition to selecting color and color contrast, it is within the scope of the present invention to select a predetermined color density of the puzzle object 40 thus essentially deciding how dark the puzzle object 40 will appear. The density will depend on the portion of the background 30 and will further depend on the level of difficulty in finding such puzzle object 40. By way of the example of FIG. 3, the probe explorer 46 is adapted with a high degree of color density forming a solid probe explorer 46 to match the high color density of the base portion 34c of the structure 34 while the toothbrush 42 is provided with a low degree of color density to blend with the surrounding stones 35 and first draw the patient's focus thereto. In another example of FIG. 5, the probe explorers 46 are also adapted with a low degree of color density to match low color density of the waterfall 37 and trees 39.

It is further presently preferred to select opacity of the puzzle object 40 so that it directs the user to view the background 30 first and then direct his or her attention to such puzzle object 40, thus increasing the difficulty of finding the puzzle object 40. By way of the example of FIG. 5, the opacity of each of the toothbrush 42 and the probe explorer 46 is selected to make them appear substantially transparent and thus more difficult to find.

Thus, essentially, the difficulty level of the picture puzzle 20 is defined, either individually and, preferably, in combination, by the number of the puzzle objects 40, by the number of common shape groups, by the feature, size and shape alignment of the puzzle objects 40 respectively relative to the feature, size or shape of the background 30 and is further defined by each of the color match, difference, density and opacity between the puzzle objects 40 and the background 30.

The difficulty level may be selected by dental practitioner depending on the age of the patients with young children being preferably exposed to picture puzzles 20 having a lesser difficulty level.

It is within the scope of the present invention to inform the patient as to quantity of puzzle objects 40 and common shape groups to be found within the background 30 by positioning such information directly onto the background 30 in a portion thereof that will not distract the patient from finding such puzzle objects 40. By way of the example of FIGS. 2-5, such information is provided by an answer key inset image 50 having each puzzle object 40, disposed within the picture puzzle 20, illustrated therewithin and defined by at least one of color, shape and quantity. Such answer key inset image 50 is advantageous as compared with prior art picture puzzles for further facilitating reduction in anxiety levels by informing the patient as to exact quantity, shape or color of puzzle objects 40 to be found within the background 30.

Each picture puzzle 20 may be affixed to a rigid surface, such as a ceiling or a wall, with adhesives or may be provided with a frame 22 or any other suitable hanging means. The position of each picture puzzle 20 will depend on the layout of the examination or the reception room, size of the picture puzzle 20 and availability of the ceiling or wall space.

The background 30 is preferably a photo image and can be obtained in a variety of different ways. It can be purchased or obtained from an authorized source from an existing library of backgrounds 30 or simply taken by an amateur photographer. The puzzle objects 40 are then added to the photo image by any conventional photo imaging software, for example such as Adobe Photo Shop.

It has been found during trials, that the picture puzzle 20 is effective in having the patient to focus his or her attention on the task of finding at least some and, preferably, all puzzle objects during a dental procedure rather than focusing on the dental procedure itself and has been found adequate in reducing patient's anxiety and discomfort levels. The dental practitioner may direct the patient to find a particular tool implement that the dental practitioner is attempting to use.

The present invention is also beneficial in educating the patient on the use and purpose of various dental tool implements and articles used both during procedures in the dental office and personal care at home. The picture puzzle 20 promotes a discussion or conversation between the practitioner and the patient enabling the patient to learn more about the objects, their uses and benefits.

Although the present invention has been shown and described in terms of providing the picture puzzle 20 as a printed document, it will be apparent to those skilled in the art, that the present invention may be applied to other forms of the picture puzzle 20. According to another embodiment of the invention, the system 10 includes each picture puzzle 20 being provided in a digital format and displayed on the display 60, for example such as liquid crystal display (LCD), either in accordance with a predetermined logic sequence or selection by the patient. Such system 10 enables the patient to select and use a greater variety of picture puzzles 20. According to yet another embodiment, the system 10 includes at least one digitally stored picture puzzle 20 in a form of a video game and/or digitally interactive means and further employs dedicated controls 62 in combination with the display 60. The controls 62 can be of any conventional control console, click or pointer type. Thus, the patient can select at least one picture puzzle 20 from a plurality of digitally stored picture puzzles 20 that would be most appealing or applicable to a particular situation or need.

Furthermore, although the present invention has been shown and described in terms of the providing the picture puzzle 20 in relationship to the field of dentistry, it will be apparent to those skilled in the art, that the present invention may be applied to other medical fields. For example, the puzzle objects 40 may be selected from the vegetable and fruit groups for promoting proper nutrition and healthy eating or educating the patient in principles thereof. Medical practitioners specializing in heart surgeries may benefit from using picture puzzles containing related tools, for example such as a stent for opening up an artery, foods that are beneficial for post operation care and other related objects.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A picture puzzle comprising:
(a) a background having at least one background object disposed therein;
(b) at least one puzzle object disposed on said background; and
(c) a predetermined matching alignment between a predetermined feature of said at least one puzzle object and a predetermined feature of said at least one background object.

2. The picture puzzle, according to claim 1, wherein said predetermined matching alignment includes a substantial alignment of at least a portion of said predetermined feature of said at least one puzzle object with a substantially identical portion of said predetermined feature of said at least one background object.

3. The picture puzzle, according to claim 1, wherein said predetermined matching alignment includes a substantial match of a color of said at least one puzzle object with a color of said predetermined feature of said at least one background object.

4. The picture puzzle, according to claim 1, wherein said predetermined matching alignment includes a substantial size match of said at least one puzzle object with said predetermined feature of said at least one background object.

5. The picture puzzle, according to claim 1, wherein said predetermined matching alignment includes a substantial shape match of said at least one puzzle object with said predetermined feature of said at least one background object.

6. The picture puzzle, according to claim 1, wherein said predetermined matching alignment includes a substantial angular match of said at least one puzzle object with said predetermined feature of said at least one background object.

7. The picture puzzle, according to claim 1, wherein said predetermined matching alignment includes a predetermined opacity of said at least one puzzle object in a predetermined relationship to said at least one background object.

8. The picture puzzle, according to claim 1, wherein said predetermined matching alignment includes a predetermined color density of said at least one puzzle object in a predetermined relationship to said at least one background object.

9. The picture puzzle, according to claim 1, wherein said picture puzzle includes an answer key disposed on said background.

10. The picture puzzle, according to claim 9, wherein said answer key includes at least one of a shape, quantity and color of said at least one puzzle object.

11. A picture puzzle comprising:
(a) a background having at least one background object disposed therein;
(b) at least one puzzle object disposed on said background;
(c) a substantial alignment of at least a portion of said predetermined feature of said at least one puzzle object with a substantially identical portion of said predetermined feature of said at least one background object;
(d) a substantial color match of said at least one puzzle object with said at least one background object;
(e) a predetermined size match of said at least one puzzle object with said predetermined feature of said at least one background object;
(f) a substantial shape match of said at least one puzzle object with said predetermined feature of said at least one background object;
(g) a substantial angular match of said at least one puzzle object with said predetermined feature of said at least one background object;
(h) a predetermined opacity of said at least one puzzle object in a predetermined relationship to said at least one background object;
(i) a predetermined color density of said at least one puzzle object in a predetermined relationship to said at least one background object; and
(j) an answer key disposed on said background, said answer key including at least one of a shape, quantity and color of said at least one puzzle object.

12. The picture puzzle, according to claim 11, wherein said picture puzzle is displayed in a digital data format on a display.

13. A method of using at least one picture puzzle for at least one of entertaining and soothing a patient awake during medical or dental procedure and promoting personal hygiene, said method comprising the steps of:
(a) providing said at least one picture puzzle having a background and at least one background object disposed thereon;
(b) positioning, on said background, at least one puzzle object closely related to said medical or dental procedure;
(c) aligning a predetermined feature of said at least one puzzle object with a predetermined feature of said at least one background object;
(d) positioning said at least one picture puzzle in a predetermined location relative to a position of said patient during said medical or dental procedure; and
(e) finding, by said patient, said at least one puzzle object disposed within said background.

14. The method, according to claim 13, wherein said aligning step includes the step of substantially aligning at least a portion of said predetermined feature of said at least one puzzle object with a substantially identical portion of said predetermined feature of said at least one background object.

15. The method, according to claim 13, wherein said aligning step includes the step of substantially matching a color of said at least one puzzle object with a color of said at least one background object.

16. The method, according to claim 13, wherein said aligning step includes the step of substantially matching a size of said at least one puzzle object with a size of said predetermined feature of said at least one background object or the step of substantially matching a shape of said at least one puzzle object with a shape of said predetermined feature of said at least one background object.

17. The method, according to claim 13, wherein said aligning step includes the step of providing a predetermined opacity of said at least one puzzle object in a predetermined relationship to said at least one background object.

18. The method, according to claim 13, wherein said aligning step includes the step of providing a predetermined color density of said at least one puzzle object in a predetermined relationship to said at least one background object.

19. A system for entertaining and soothing a patient awake during medical or dental procedure, said system comprising at least one picture puzzle positioned in a predetermined location so as to be directly viewed by a patient undergoing such medical or dental procedure, said at least one picture puzzle including a background having at least one background object disposed therein, at least one puzzle object disposed on said background and a predetermined matching alignment between a predetermined feature of said at least one puzzle object and a predetermined feature of said at least one background object.

20. A method of using at least one picture puzzle for educating a person about at least one of tools used in a medical or dental procedure and items used in health care and personal hygiene, said method comprising the steps of:
(a) providing said at least one picture puzzle having a background and at least one background object disposed thereon;
(b) positioning, on said background, at least one puzzle object closely related to said medical or dental procedure;
(c) aligning a predetermined feature of said at least one puzzle object with a predetermined feature of said at least one background object;
(d) finding, by said patient, said at least one puzzle object disposed within said background; and
(e) learning, by said patient, about use of said at least one puzzle object found in step (d).
